(19) United States
(12) Patent Application Publication
(10) Pub. No.: US 2022/0320741 A1
(43) Pub. Date: Oct. 6, 2022

(54) FOUR-ARM HELICAL ANTENNA

(71) Applicant: COMNAV TECHNOLOGY LTD., Shanghai (CN)

(72) Inventor: Peng ZHANG, Shanghai (CN)

(73) Assignee: COMNAV TECHNOLOGY LTD., Shanghai (CN)

(21) Appl. No.: 17/314,793

(22) Filed: May 7, 2021

(30) Foreign Application Priority Data
Apr. 2, 2021 (CN) 202110362635.6

(51) Int. Cl. H01Q 11/08; H01Q 21/28; H01Q 1/22; H01Q 5/371

(52) U.S. Cl. CPC H01Q 11/08; H01Q 21/28; H01Q 1/2208; H01Q 5/371

(57) ABSTRACT

A four-arm helical antenna is provided, including: a metal top surface; four groups of helical antennas connected to the metal top surface to constitute a hollow cylinder, wherein any group of helical antennas comprises an antenna main arm and an antenna branch aria connected to each other, and the antenna main arm comprises a first bending portion arranged on a side surface of the hollow cylinder and a second bending portion arranged on a top surface of the hollow cylinder, and the antenna branch arm comprises a third bending portion arranged on the side surface of the hollow cylinder. The whole four-arm helical antenna is easy to adjust, and the antenna size can be adjusted flexibly according to installation requirements, and it's more suitable for miniaturization application requirements of the four-arm helical antenna.

### CROSS-REFERENCE TO RELATED APPLICATIONS

This application is based upon and claims priority to Chinese Patent Application No. 202110362635.6, filed on Apr. 2, 2021, the entire contents of which are incorporated herein by reference.

### TECHNICAL FIELD

The present disclosure relates to a technical field of satellite navigation and communication equipment, and more particularly to a four-arm helical antenna.

### BACKGROUND

Global satellite navigation system has a wide range of applications in all aspects of society. Compared with single satellite navigation system, multi-mode navigation has the advantages of wider coverage, higher navigation accuracy and more stable operation, which makes multi-mode navigation become the development trend of satellite navigation in the future. As an important part of satellite navigation system, the performance of the antenna has a great impact on the performance of navigation system. Therefore, it is of great significance to research on the multimode satellite navigation antenna.

The four-arm helical antenna is a kind of antenna with compact structure, light weight and little influence by the grounding plate. It is very suitable for the carrier with high requirements for size and weight, such as the application of the four-arm helical antenna in the unmanned aerial vehicle to realize the navigation, positioning and direction-finding functions of the unmanned aerial vehicle. With the development of the unmanned aerial vehicle application, the requirement of positioning accuracy is higher and higher, and with the expansion of the unmanned aerial vehicle application scenarios, the use environment of the unmanned aerial vehicle is more and more complex, such as the complex electromagnetic environment in the city, which will cause serious interference to the performance of the four-arm helical antenna, therefore, the four-arm helical antenna is required to have stronger satellite signal receiving ability and multi navigation system coverage ability, so as to improve the real-time navigation and positioning accuracy of the unmanned aerial vehicle in complex electromagnetic environment.

The performance of the four-arm helical antenna is closely related to the antenna size, and its main performance indicators are gain and bandwidth. In general, the larger the size of the four-arm helical antenna, the better the performance, the higher the height of the antenna, the higher the gain, the larger the diameter of the antenna, and the wider the bandwidth. The four-arm helical antenna in the existing technology cannot have the advantages of both small size and high performance. If the size of the antenna is too large, its installation will be affected. If the size of the antenna is reduced, the performance of the antenna will be degraded, which will further affect the positioning of the unmanned aerial vehicle in complex environment, and even lead to collision and other accidents.

### SUMMARY

In the present disclosure, a four-arm helical antenna is disclosed, including: a metal top surface; and four groups of helical antennas connected to the metal top surface to constitute a hollow cylinder, wherein any group of helical antennas includes an antenna main arm and an antenna branch arm connected to each other, and the antenna main arm includes a first bending portion arranged on a side surface of the hollow cylinder and a second bending portion arranged on a top surface of the hollow cylinder, and the antenna branch arm comprises a third bending portion arranged on the side surface of the hollow cylinder.

### BRIEF DESCRIPTION OF THE DRAWINGS

The nonrestrictive and non-exhaustive embodiments of the present disclosure are described in conjunction with the accompanying drawings. Unless otherwise stated, same reference signs in the figures refer to same or similar elements. The assemblies and components are not drawn to scale, but may be drawn out of scale to make the embodiments of the present disclosure more understandable.

FIG. 1 is a schematic stereogram of a four-arm helical antenna according to an embodiment of the present disclosure;

FIG. 2 is a top view of a four-arm helical antenna according to an embodiment of the present disclosure:

FIG. 3 is a gain effect view of a four-arm helical antenna according to an embodiment of the present disclosure.

### DETAILED DESCRIPTION

In the following, embodiments will be described in detail to illustrate general concept of the present disclosure, but are not intended as a limitation to the protection scope of the present disclosure. The specific features can be used in conjunction with other described features in all kinds of combination and arrangement.

It should be understood that the term “and/or” in this present disclosure only describes the association relationship of associated objects, indicating that there can be three kinds of relationships, for example, a and/or B, which can indicate that there are only A, B, and A and B. in addition, the character “/” in this present disclosure generally indicates that the front and back associated objects are a kind of “or” relationship.

It should be understood that when a unit is referred to as “connected”, or “coupled” to another unit, it can be directly connected to another unit or intermediate elements may exist between the two units. In contrast, when a unit is called “directly connected ” or “directly coupled” to another unit, there is no intermediate unit. Other words used to describe the relationship between units should be interpreted in a similar way (e.g., “between” vs. “directly between”, “adjacent” vs. “directly adjacent”, etc.)

The terms used herein are used for describing specific embodiments only and are not intended to limit the exemplary embodiments of the present disclosure. As used herein, the singular forms “a”, “one” and “the” are intended to include the plural unless the context specifically indicates the contrary. It should also he understood that the terms “include”, “comprise”, and/or “have” when used herein specify the existence of declared features, integers, steps, operations, units and/or components, and do not exclude the existence or addition of one or more other features, quantities, steps, operations, units, components and/or combinations thereof.

It should also be noted that in some alternative embodiments, the functions/actions that appear may be in a different order than those in the accompanying drawings. For example, depending on the function/action involved, the two diagrams shown in succession can actually be executed concurrently or sometimes in reverse order.

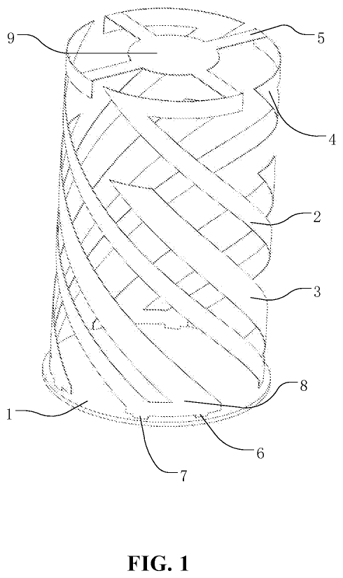

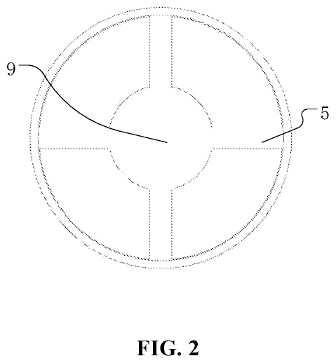

Refer to FIG. 1 and FIG. 2, FIG. 1 is a schematic stereogram of a four-arm helical antenna provided by an embodiment of the present disclosure; FIG. 2 is a top view of a four-arm helical antenna provided by an embodiment of the present disclosure. The embodiment proposes a miniaturized full-frequency four-arm helical antenna, including a circular bottom 1, a metal top surface 9, and four groups of helical antennas connected to the metal top surface 9 and the circular bottom surface 1 to form a hollow cylinder. Any group of helical antennas includes an antenna main arm 2 and an antenna branch arm 3. The antenna main arm 2 includes a first bending portion 4 arranged on a side surface of the hollow cylinder and a second bending portion 5 arranged on a top surface of the hollow cylinder, and the antenna branch arm 3 includes a third bending portion 8 arranged on the side surface of the hollow cylinder. In FIG. 1, the first bending portion 4 is near the metal top surface only as an example. During the implementation, the first bending portion 4 can be set at any position such as a middle or a bottom of the side surface of the hollow cylinder, and this embodiment does not limit it.

The embodiment adopts four groups of helical antennas with a same shape, and two adjacent groups of helical antennas have the same distance and are designed to surround the outside of the dielectric cylinder in a same direction. The antenna main arm 2 and the antenna branch arm 3 finally form four bending connecting arms, reducing the diameter and height of the helical antenna. On the premise of achieving the same signal receiving and sending effect, the antenna height can be reduced by 15 mm.

The four antenna main arms 2 are connected to the metal top surface 9. The length of the antenna main arm 2 can be adjusted by adjusting the area of the metal top surface 9, and the distance around the cylinder of the antenna main arm 2 can he changed synchronously, and the circular and radial dimensions of the helical antenna can be changed, and the application range of the four-arm helical antenna can be expanded, which is more suitable for miniaturization application requirements of the four-arm helical antenna.

Alternatively, the helical antenna is a metal helical antenna and the circular bottom 1 is a PCB board. Therefore, the above components can be connected by solder and the current is connected through the route.

Alternatively, a width of the antenna main arm 2 and a width of the antenna branch arm 3 of any group of the helical antennas can be the same with or different from each other.

Alternatively, a distance between any two adjacent groups of the helical antennas can be the same with or different from each other.

Alternatively, a total length of the antenna main arm 2 is ½ of a corresponding wavelength of a resonance center frequency of a high frequency section of the helical antenna, wherein a terminal end of the antenna main arm 2 is connected to a signal line of the circular bottom 1 through a feeding branch 7.

Alternatively, a total length of the antenna branch arm 3 is ¼ of a corresponding wavelength of a resonance center frequency of a low frequency section of the helical antenna, wherein a terminal end of the antenna branch arm 3 is connected to the circular bottom 1 surface through a short-circuit branch 6.

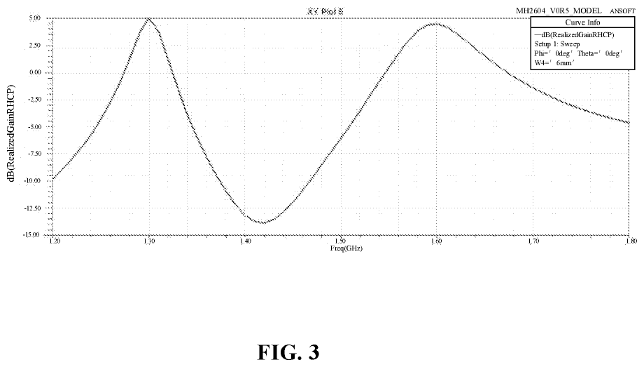

Alternatively, the total length of the antenna main arm 2 is ½ of the corresponding wavelength of the resonance center frequency of the high frequency section of the helical antenna, which is used to cover the high-frequency segment signal, wherein, it is connected to the signal line of the PCB board 1 through the feeding branch 7, which is used for feeding, receiving and sending signals of the whole antenna. The total length of the antenna branch arm 3 is ¼ of the corresponding wavelength of the resonance center frequency of the low frequency section of the helical antenna, which is used to cover the low-frequency signal. Among them, the antenna branch arm 3 is grounded through a short-circuit branch 6, which is in short circuit contact with the base plate to adjust the antenna impedance. The ½ wavelength design of the antenna main arm 2 combines with the ¼ wavelength design of the antenna branch arm 3, and can optimize the gain of high frequency and low frequency section of the four-arm helical antenna at the same time, and expand the bandwidth of the four-arm helical antenna. As shown in FIG. 3, it is a full frequency four-arm helical antenna gain effect diagram of the present disclosure.

Communication or navigation antenna usually requires multi-hand operation. The present disclosure can still cover GPS L1/L2/L5, BD B1/B2/B3, GLONASS G1/G2, Galileo E1/E2/E5a/E5b and other frequency points when the antenna size is reduced.

In the embodiment, the width of the antenna main arm 2 is different from that of the antenna branch arm 3. The design variable is added. The antenna performance can he optimized by adjusting the relative width and distance of each group of the antenna main arm 2 and the antenna branch arm 3. The antenna main arm 2 is used for feeding with a wide band; The antenna branch arm 3 is grounded and the band width is narrow. The width of the antenna branch arm 3 of the present disclosure is larger than the width of the antenna main arm 2, and can effectively widen the antenna bandwidth. In the actual installation, the optimal performance of each group is achieved by adjusting the distance between each group of the antenna main arm 2 and the antenna branch arm 3 to adjust the energy of the antenna main arm 2 coupled to the antenna branch arm 3.

Optionally, the rotation direction of any group of helical antennas is left-rotation or right-rotation. The helix rising angle of the antenna main arm 2 and the helix rising angle of the antenna branch arm 3 included in any group of helical antennas can be the same with or different from each other. The antenna main arm 2 and the antenna branch arm 3 are arranged in the helical direction of the dielectric cylinder to receive the circular polarized electromagnetic wave. The antenna main arm 2 adopts a two-stage bending structure, which makes the whole helical antenna more compact and reduces the radial dimension of the antenna.

Compared with the prior art, the embodiment of the present disclosure has at least one of the following advantages.

With the combination design of ½ wavelength of the antenna main arm and ¼ wavelength of the antenna support arm, the gain of high and low frequency bands of the four arm helical antenna is optimized to achieve full frequency coverage; the antenna main arm and the antenna branch arm adopt different widths to increase the design variables, and the antenna performance can be optimized by adjusting the relative width and the distance of the two arms; the antenna main arm is connected to the antenna branch arm through the strip connecting arm, and finally the four bending connecting arms are formed to reduce the size of the antenna. The structure of the whole four-arm helical antenna is easy to adjust, and the antenna size can be flexibly adjusted according to the installation requirements, which is more suitable for the miniaturization application requirements of the four-arm helical antenna.

Through the description of the above embodiments, those skilled in the art can clearly understand that the present disclosure can be realized by means of software and necessary hardware platform, and of course, it can be implemented by hardware. Based on this understanding, all or part of the technical scheme of the present disclosure contributing to background technology can be embodied in the form of software products. The computer software products can be stored in storage media, such as rom/ram, magnetic disk, CD-ROM, etc., including several instructions for making a computer device (can be a personal computer, server, etc., or network equipment, etc) a method for executing some parts of each embodiment or embodiment of the present disclosure.

In embodiments of the present disclosure, the unit/module may be implemented in software for execution by various types of processors. For example, an identified executable code module may include one or more physical or logical blocks of computer instructions, which, for example, can be constructed as objects, processes, or functions. Nevertheless, the executable code of the identified module does not need to be physically located together, but may include different instructions stored in different bits, which constitute units/modules and achieve the specified purpose of the unit/module when they are logically combined.

When the unit/module can be realized by software, considering the level of existing hardware technology, the unit/module can be realized by software. Without considering the cost, the technicians in the art can build corresponding hardware circuits to realize corresponding functions. The hardware circuits include conventional VLSI (Very Large-Scale Integration) circuits or gate arrays, as well as logic chips, an existing semiconductor, such as a transistor, or other discrete elements. The module can also he realized by programmable hardware devices, such as a field programmable gate array, a programmable array logic device, a programmable logic equipment, etc.

It should be readily understood that the description of the embodiments is exemplary and explanatory only, and are not intended as a limitation to the protection scope of the present disclosure. Indeed, new methods and systems can be realized in all kinds of forms. Besides, omitting, modifications and substitutions can be made to the forms of the methods and systems, without departing from the spirit and scope of the present disclosure. The attached claims and equivalent definitions mean to cover all the forms and modifications within the spirit and scope of the present disclosure.

What is claimed is:

1. A four-arm helical antenna comprising:
a metal top surface;
four groups of helical antennas connected to the metal top surface to constitute a hollow cylinder, wherein any group of helical antennas comprises an antenna main arm and an antenna branch arm connected to each other, and the antenna main arm comprises a first bending portion arranged on a side surface of the hollow cylinder and a second bending portion arranged on a top surface of the hollow cylinder, and the antenna branch arm comprises a third bending portion arranged on the side surface of the hollow cylinder.

2. The four-arm helical antenna according to claim 1, wherein, the helical antennas are metal helical antennas.

3. The four-arm helical antenna according to claim 1, wherein, the four-arm helical antenna further comprises a circular bottom surface, and the circular bottom surface is a PCB board.

4. The four-arm helical antenna according to claim 1, wherein, a rotation direction of any group of the helical antennas is left-rotation or right-rotation.

5. The four-arm helical antenna according to claim 1, wherein, a helical rising angle of the antenna main arm and a helical rising angle of the antenna branch arm of any group of the helical antennas can be the same with or different from each other.

6. The four-arm helical antenna according to claim 1, wherein, a total length of the antenna main arm is ½ of a corresponding wavelength of a resonance center frequency of a high frequency section of the helical antenna, wherein a terminal end of the antenna main arm is connected to a signal line of the circular bottom through a feeding branch.

7. The four-arm helical antenna according to claim 3, wherein, a total length of the antenna branch arm is ¼ of a corresponding wavelength of a resonance center frequency of a low frequency section of the helical antenna, wherein a terminal end of the antenna branch arm is connected to the circular bottom surface through a short-circuit branch.

8. The four-arm helical antenna according to claim 1, wherein, a width of the antenna main arm and a width of the antenna branch arm of any group of the helical antennas can be the same with or different from each other.

9. The four-arm helical antenna according to claim 1, wherein, a distance between any two adjacent groups of the helical antennas can be the same with or different from each other.
